(19) United States
(12) Patent Application Publication
(10) Pub. No.: US 2015/0104601 A1
(43) Pub. Date: Apr. 16, 2015

(54) ADHESIVE ARTICLE

(71) Applicant: 3M INNOVATIVE PROPERTIES COMPANY, St. Paul, MN (US)

(72) Inventors: Maria A. Appeaning, St. Paul, MN (US); Albert I. Everaerts, Oakdale, MN (US); Yi He, Roseville, MN (US); David J. Kinning, Woodbury, MN (US)

(21) Appl. No.: 14/403,774

(22) PCT Filed: May 28, 2013
(86) PCT No.: PCT/US2013/042838

§ 371 Date: Nov. 25, 2014

Related U.S. Application Data
(60) Provisional application No. 61/653,971, filed on May 31, 2012.

(51) Int. Cl. C09J 7/02; C09J 133/26

(52) U.S. Cl. CPC C09J 7/0232; C09J 7/0217; C09J 133/26
USPC 428/41.4; 522/8

(57) ABSTRACT

The present invention comprises adhesive articles, adhesive compositions, and release liners. The release liners include silicone-based release formulations that can provide average and static release forces desirable for converting and handling soft adhesives, particularly adhesives of the type used in the electronics industry. In one embodiment, the silicone-based formulations include addition-cure silicone-based release formulations.

### BACKGROUND

Capacitive touch technology has found increasing utility in various applications, including hand-held mobile devices, netbooks and laptop computers. Compared to other touch technologies, capacitive touch enables very sensitive response as well as features such as multi-touch. Optically clear adhesives (OCAs) are often used for bonding purposes (e.g., attachment of different display component layers) in the capacitive touch panel assembly.

Not only do OCAs provide mechanical bonding, but they also can greatly increase the optical quality of the display by eliminating air gaps that reduce brightness and contrast. The optical performance of a display can be improved by minimizing the number of internal reflecting surfaces, thus it may be desirable to remove or at least minimize the number of air gaps between optical elements in the display.

In display assembly, bonding a touch panel or display panel (such as a liquid crystal display (LCD) panel) to a three-dimensional (3D) cover glass by means of an optically clear adhesive can sometimes be challenging. Indeed, newer designs use cover glasses having a thick (approaching 50 micrometers) ink step around the perimeter or frame of the cover glass, generating a substrate that is no longer flat but is a 3-D lens. The region encompassed by the ink step is often referred to as a gap. In addition to the large ink step, other 3D features that may require good adhesive wetting of any of the display components, include things like the presence of a flex connector, slight curvature of the components, thicker ITO patterns, presence of raised integrated circuits on a touch panel and the like.

There is thus an increasing need for soft OCAs, which enable better wetting of thick inks on the display. Additionally, they can improve stress relief as a result of the display module assembly process. Such stress relieving features are particularly beneficial to reduce Mura (optical image distortion that may result from dimensional distortion) when bonding Liquid Crystal Display Module (LCM) and can also minimize delayed-bubble formation. A further beneficial feature of soft OCAs is short assembly cycle times.

However, it can be difficult to remove soft OCAs from conventional release liners without causing defects.

In the case of release liners, silicone-based release coatings dominate the market because they have lower release forces compared to other coatings. Silicone release coatings are typically formed from the reaction of functional polydimethylsiloxane precursors to form a crosslinked network. Traditionally, the curing of the silicone network is thermally initiated and occurs by either an addition or a condensation reaction. Radiation curing of functional or non-functional silicone, using high intensity ultraviolet light or an electron beam (EB), is another method used to obtain a cross-linked network.

Solvent-free addition-cure formulations yield cured coatings with much higher crosslink densities than do typical solvent formulations, due to lower molecular weight and higher level of functionality of the base polymers. This difference in crosslink density can lead to profound changes in the coating's properties, e.g. coefficient of friction (COF). The difference in crosslink density may also affect how the coating interacts with specific adhesives and influence corresponding release liner-adhesive characteristics, such as, release levels, coatability, etc. It is challenging to identify a liner that meets all the performance requirements for a soft optically clear adhesive, thus, there is still a need for release chemistries to solve the problem of release of a soft adhesive from a release liner.

### SUMMARY

The present disclosure is directed to adhesive articles, adhesive compositions, and release liners. In certain embodiments, the release liners used therein include silicone-based release formulations, particularly addition-cure silicone-based release formulations, that can provide average and static release forces desirable for converting and handling soft (and optionally optically clear) adhesives, particularly adhesives of the type used in the electronics industry. In one embodiment, the release forces, both initial and average, between the soft adhesives and the release liners, are controlled by the cross-linking densities of the silicone release coating formulations.

In one embodiment, the present disclosure provides an adhesive article that includes a release liner having a release layer and at least one adhesive layer adjacent to the release layer. The release layer includes a crosslinked silicone polymer and has a coefficient of friction of at least about 0.4. The adhesive layer includes an adhesive composition that maintains a tan delta value of at least about 0.5 at a temperature of between about 25° C. and about 100° C.

In certain embodiments, the release layer has a coefficient of friction of at least about 0.6, and in certain embodiments, the release layer has a coefficient of friction of at least about 0.8.

In certain embodiments, the crosslinked silicone is derived from at least one reactive silicone precursor, wherein the silicone precursor includes two or more reactive groups. Suitable reactive groups include epoxy, acrylate, silanol, alkoxylsilane, acyloxysilane or ethylenically unsaturated groups. In certain embodiments, the crosslinked silicone polymer is derived from at least one silicone precursor including two or more epoxy or acrylate groups. In certain embodiments, the crosslinked silicone polymer is derived from at least one silicone precursor including two or more silanol or ethylenically unsaturated groups and at least one hydride-functional silicone crosslinker. In certain embodiments, at least one reactive silicone precursor is a reactive silicone gum including at least one type of reactive group. In one embodiment, the reactive silicone gum has a number average molecular weight of at least 150,000. In certain embodiments, the reactive silicone gum comprises ethylenically unsaturated groups, and in certain embodiments, the reactive silicone gum comprises silanol groups. In certain embodiments, the crosslinked silicone is derived from one or more reactive silicone precursors crosslinked using a platinum catalyst.

In certain embodiments, the adhesive composition maintains a tan delta value of between about 0.5 and about 1.5 at a temperature of between about 25° C. and about 100° C. In certain embodiments, the adhesive composition maintains a tan delta value of between about 0.5 and about 1.0 at a temperature of between about 25° C. and about 100° C.

In certain embodiments, the adhesive composition maintains a tan delta value of between about 0.6 and about 0.8 at a temperature of between about 25° C. and about 100° C.

In certain embodiments, the adhesive composition is derived from components comprising: an alkyl (meth)acrylate ester, wherein the alkyl group has 1 to 18 carbon atoms; a hydrophilic copolymerizable monomer; and a free-radical generating initiator. In certain embodiments, the adhesive composition is crosslinked.

In certain embodiments, the adhesive composition is derived from components comprising: an alkyl (meth)acrylate ester, wherein the alkyl group has 1 to 18 carbon atoms; a hydrophilic, hydroxyl-functional copolymerizable monomer; a polar monomer other than the hydrophilic, hydroxyl-functional copolymerizable monomer; and a free-radical generating initiator.

In certain embodiments, the adhesive composition is derived from components comprising: an alkyl (meth)acrylate ester, wherein the alkyl group has 1 to 18 carbon atoms; a hydroxyl-functional copolymerizable monomer; a (meth)acrylamide monomer; and a free-radical generating initiator.

In certain embodiments, the present disclosure provides an adhesive composition derived from components including 50 to 85 parts of an alkyl (meth)acrylate ester, wherein the alkyl group has 1 to 18 carbon atoms; 10 to 40 parts of a hydroxyl-functional copolymerizable monomer; 5 to 20 parts of a (meth)acrylamide monomer; and a free-radical generating initiator.

In certain embodiments, the alkyl(meth)acrylate ester is selected from the group consisting of 2-ethylhexyl acrylate (2-EHA), isobornyl acrylate (IBA), iso-octylacrylate (IOA), butyl acrylate (BA), and combinations thereof.

In certain embodiments, the (meth)acrylamide monomer is selected from the group consisting of: acrylic amide, diacetone acrylamide, N-tert-octylacrylamide, N,N-dimethylacrylamide, and N-morpholino acrylate.

In certain embodiments, the hydrophilic copolymerizable monomer is selected from the group consisting of acrylic acid (AA), 2-hydroxyethyl acrylate (HEA), hydroxypropyl acrylate (HPA), ethoxyethoxyethyl acrylate (V-190), acrylic amide (Acm), diacetone acrylamide, N-tert octylacrylamide, N,N-dimethylacrylamide, N-morpholino acrylate (MoA), and combinations thereof.

In certain embodiments, the hydroxyl-functional copolymerizable monomer is selected from the group consisting of: 2-hydroxyethyl acrylate, and 2-hydroxy-propyl acrylate, and 4-hydroxybutylacrylate.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a cross-sectional view of an exemplary adhesive article of the present disclosure.

FIG. 2a is a cross-sectional view of a release liner failure test configuration.

FIG. 2b is a top view of the release liner failure test configuration.

### DETAILED DESCRIPTION OF ILLUSTRATIVE EMBODIMENTS

“Release force” is defined as the amount of force required to peel or separate a release liner from an adhesive surface. It is desirable that the release liner has a release force which is low enough to enable the release liner to be easily removed from the adhesive surface, but not so low that the release liner will become prematurely separated from the adhesive surface by forces normally encountered in handling and processing.

The term “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The present disclosure is directed to adhesive articles, adhesive compositions, and release liners. The adhesive compositions can be used in adhesive articles, for example, assembling optical displays. The adhesive compositions have desirable flow characteristics that lead to at least one of the following desirable characteristics: good high ink-step lamination, short assembly cycle times, and durable laminates.

A laminate is defined as including at least a first substrate, a second substrate and an adhesive positioned between the first and second substrates. The adhesive composition is designed to allow for trapped bubbles formed during lamination to easily escape the adhesive matrix and the adhesive substrate interface, resulting in a bubble-free laminate after autoclave treatment. As a result, few, if any, lamination defects are observed after lamination and autoclave treatment. The combined benefits of good substrate wetting and easy bubble removal enables an efficient lamination process with greatly shortened cycle times. Additionally, the good stress relaxation and substrate adhesion from the adhesive allow for durable bonding of the laminate (e.g., no bubble/delamination after accelerated aging tests). To achieve these effects, the adhesive composition has certain rheological properties, such as low shear storage modulus (G′) and high tan delta values.

Optical materials may be used to fill gaps between optical components or substrates of optical assemblies. Optical assemblies that include a display panel bonded to an optical substrate may benefit if the gap between the two is filled with an optical material that matches or nearly matches the refractive indices of the panel and the substrate. For example, sunlight and ambient light reflection inherent between a display panel and an outer cover sheet may be reduced. Color gamut and contrast of the display panel can be improved under ambient conditions. Optical assemblies having a filled gap can also exhibit improved shock-resistance compared to the same assemblies having an air gap.

An optical assembly having a large size or area can be difficult to manufacture, especially if efficiency and stringent optical quality are desired. A gap between optical components may be filled by pouring or injecting a curable composition into the gap followed by curing the composition to bond the components together. However, these commonly used compositions have long flow-out times which contribute to inefficient manufacturing methods for large optical assemblies.

An optically clear adhesive may be used in transfer tape format to fill the air gap between the display substrates. In this process, a liquid adhesive precursor composition of this invention can be applied on a “siliconized” release liner or between two “siliconized” release liners, at least one of which is transparent to UV radiation (which is useful for curing). The adhesive precursor composition can then be cured (polymerized and/or crosslinked) by exposure to actinic radiation at a wavelength at least partially absorbed by a photoinitiator contained therein. Alternatively, a thermally activated free-radical initiator may be used, where a liquid adhesive precursor composition of this disclosure can be coated on a “siliconized” release liner or between two “siliconized” release liners and exposed to heat to complete the curing process of the composition. A transfer tape that includes an adhesive (e.g., a pressure-sensitive adhesive) can be thus formed. The formation of a transfer tape can reduce stress in the adhesive by allowing the cured adhesive to relax prior to lamination. For example, in a typical assembly process, the liner with lower release can be removed from the transfer tape and the adhesive can be applied to the display assembly. Then, the second release liner can be removed and lamination to the substrate can be completed. When the substrate and the display panel are rigid, adhesive bonding can be assisted with vacuum lamination equipment to assure that bubbles are not formed in the adhesive or at the interfaces between the adhesive and the substrate or display panel. Finally, the assembled display components can be submitted to an autoclave step to finalize the bond and make the optical assembly free of lamination defects.

When the cured adhesive transfer tape is laminated between a printed lens and a second display substrate, prevention of optical defects can be even more challenging because the fully cured adhesive may have to conform to a sometimes large ink step (e.g., 50-70 μm) and the total adhesive thickness acceptable in the display may only be 150-250 μm. Completely wetting this large ink step during initial assembly (for example, when printed lens is laminated to the second substrate with the optically clear adhesive transfer tape of this disclosure) is very important, because any trapped air bubbles may become very difficult to remove in the subsequent display assembly steps. The optically clear adhesive transfer tape preferably has sufficient compliance (for example, low shear storage modulus, G′, at lamination temperature, typically 25° C., of <10⁵ Pascal (Pa), when measured at 1 Hz frequency). This enables good ink wetting, by allowing the adhesive to deform quickly, and to comply with the sharp edge of the ink step contour. The adhesive of the transfer tape also preferably has sufficient flow to not only comply with the ink step but also wet more completely to the ink surface. The flow of the adhesive can be reflected in the high tan delta value of the material over a broad range of temperatures (e.g., tan δ of at least 0.5, preferably greater than 0.5) between the glass transition temperature (Tg) of the adhesive (measured by DMTA) and about 100° C. or slightly higher). The stress caused by the rapid deformation of the optically clear adhesive tape by the ink step requires the adhesive to respond much faster than the common stress caused by a coefficient of thermal expansion mismatch, such as in polarizer attachment applications where the stress can be relieved over hours instead of seconds or shorter. However, even those adhesives that can achieve this initial ink step wetting may still have too much elastic contribution from the bulk rheology. This can cause the bonded components to distort, which is not acceptable. Even if these display components are dimensionally stable, the stored elastic energy (due to the rapid deformation of the adhesive over the ink step) may find a way to relieve itself by constantly exercising stress on the adhesive, eventually causing failure. Thus, as in the case of liquid bonding of the display components, the design of a transfer tape to successfully bond the display components requires a delicate balance of adhesion, optics, drop test tolerance, as well as compliance to high ink steps, and good flow even when the ink step pushes into the adhesive layer up to as much as 30% or more of its thickness.

Furthermore, controlled release of a release liner from a soft adhesive is challenging due to the low modulus and high tan delta of the adhesive. When combined with adhesive thicknesses in the range of 50-400 microns, the release performance can become very challenging, especially since the adhesives require reliable and smooth release, which does not mar or otherwise irreversibly deform the adhesive. Typically, soft, thick and flowable adhesives no longer release in the same reliable way, as do higher modulus and stiffer adhesives, even when coated at the same thickness. Thus, improved release liners are required. Table 1 is a comparison of the storage modulus, measured by DMTA, for exemplary stiff and soft adhesives.

TABLE 1
Comparison of Storage Modulus of Stiff and Soft Adhesives

| | |
|---|---|
| Temperature | Storage modulus (G′) |

| (° C.) | Stiff Adhesive* (Pa) | Soft Adhesive** |
|---|---|---|
| 0 | 3008920 | 667169 |
| 25 | 222012 | 82880.3 |
| 50 | 82675.9 | 32809.2 |
| 75 | 57546.8 | 16130.8 |

*Available under the trade designation 3M OPTICALLY CLEAR ADHESIVE 8180, from 3M Company, St. Paul, Minnesota
**Available under the trade designation 3M CONTRAST ENHANCEMENT FILM CEF2210, from 3M Company.

The polymer network from a soft adhesive having a high tan delta is more likely to irreversibly deform during peeling from the release coating. This deformation decreases the localized force concentration at the adhesive/release liner interface, thereby making separation of the adhesive from the release liner more difficult. In addition, some of the adhesives described herein are directly coated in syrup form (monomers with some polymer fraction to provide coatable viscosity) on the release liner. In this case, some of the monomers may slightly penetrate into the release coating. This may generate some slight interpenetration of the cured adhesive and the cured release coating further increasing the release force. Finally, due to the rheological behavior of the release coating, the overall release force measured and release behavior of the adhesive may be further influenced. The release force for the stiff adhesive of Table 1 is 18 g/inch (7.1 g/cm), and that of the soft adhesive of Table 1 is 49 g/inch (19.3 g/cm). The release force was determined using a conventional peel test, at a peel rate of 300 inch/min. Both adhesives were 10 mils (0.254 mm) thick and the release liner, available under the trade designation T10 from CP Films, Inc., Martinsville, Va., was 2 mils (0.051 mm) thick. The average release force for the softer adhesive was 3 times that of the stiffer adhesive.

It is desirable to be able to control both the average release force and static release force from the soft adhesives. Too high of an average release force is more likely to cause irreversible deformation of the soft adhesive and optical defects on the adhesive die-cut during liner removal.

In some embodiments, it may be desirable to cure the adhesive precursor composition or the adhesive syrup between two liners. Whereas coating on a highly crosslinked release liner may be challenging due to wetting (of the adhesive syrup) limitations, coating between liners is more forgiving because the fluid is forced to wet by being sandwiched between the liners.

A preferred adhesive article includes two release liners having differential release force. Preferably, the two release liners have a differential release force (the ratio of the average release force of the high release force liner to that of the lower release force liner) of at least about 1.5:1, at least about 2.0:1, or even at least about 3.0:1. For example, a high COF (coefficient of friction) release liner of the present disclosure that is considered to have a low release force, typically demonstrates an average release force of no more than about 40 g/inch at a peel rate of 90 inches/minute (229 cm/minute) at a 180° peel angle.

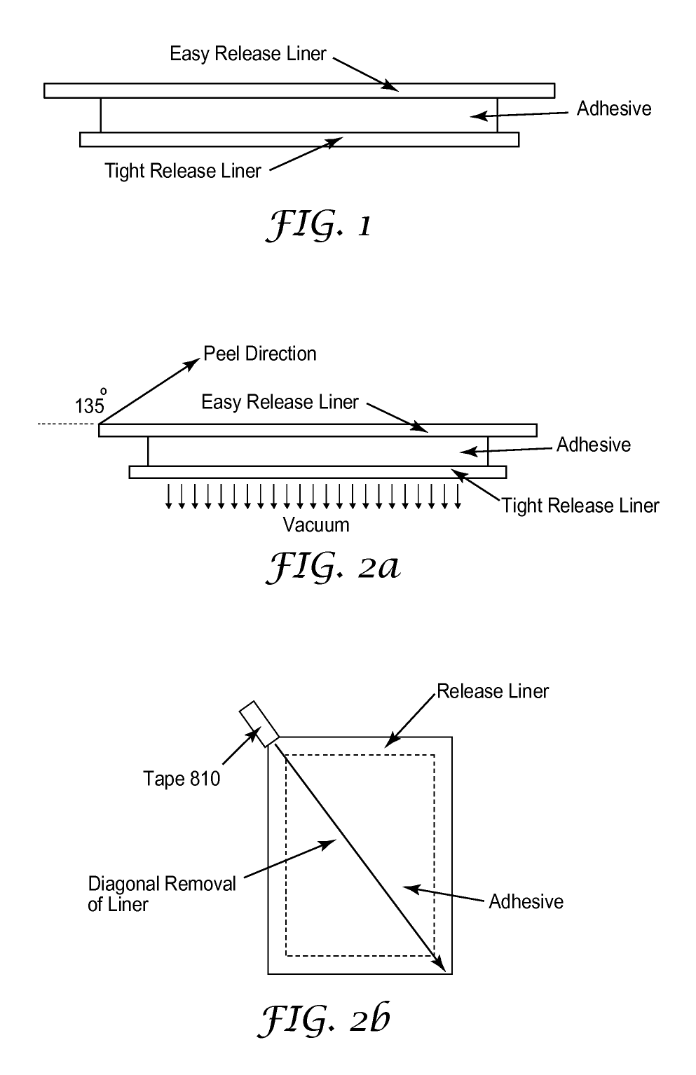

A cross-sectional view of an exemplary adhesive article of the present disclosure is shown in FIG. 1. It is a 3-layer construction, a low release force liner, i.e., an “easy release” liner, on the very top, followed by a layer of adhesive and a high release force liner. i.e., a “tight” liner. In this exemplary embodiment, the dimensions of the easy release liner are slightly larger than the dimensions of the layer of adhesive to facilitate its removal from the adhesive layer. During use, the sample is normally fixed onto a vacuum stage with various sized openings under a finite amount of vacuum (negative pressure), 2-70 kPa. The release liners may be removed using an automatic de-taping method, without any manual initiation, or manually, generally, at a consistent peel speed and angle. Any interference with the automatic liner removal or routine manual process is problematic and may cause lower productivity. The failure could be even more costly when the adhesive is already laminated onto the component. Also, any failure during liner removal could result in optical defects on the die-cut or lifting and distortion of the adhesive itself. Liner removal failure is distinguished by one or more of the following failure mode(s): a) irrecoverable bending of sample when the easy liner is being removed which results in leakage of vacuum; b) detachment of the adhesive article from the vacuum stage because of vacuum leakage; c) separation of adhesive layer from the tight liner when the easy liner is removed; d) irrecoverable shift of adhesive article's position on the vacuum stage during the process of removing the easy liner; or e) adhesive deformation along its edges when the release liner is removed. Combinations of two or more failure modes, is possible.

### Release Liner

A typical release liner of the present disclosure includes a backing or a substrate with a release layer disposed thereon. This release layer is adjacent an adhesive layer in an adhesive article of the present disclosure. The release layer includes a crosslinked silicone polymer and has a coefficient of friction of at least about 0.4. In certain embodiments, the release layer has a coefficient of friction of at least about 0.6, and in certain embodiments, at least about 0.8. Preferably, the coefficient of friction is no greater than 2.0, more preferably no greater than 1.7, and even more preferably no greater than 1.4.

As mentioned above, higher crosslink density can lead to higher COF. Increasing the crosslinking density of the release coating can occur through the use of functionalized silicone base polymers with low molecular weight between functional groups. The use of such a high crosslink density results in a high COF liner. The addition of a small amount of a high molecular weight silicone gum can lower the COF.

For certain embodiments, the number average molecular weight between functional groups of the silicone base polymer is about 20,000 or less. For certain embodiments, the number average molecular weight between functional groups is at least about 500, and often at least about 2,000. Similarly, for certain embodiments, the number average molecular weight of the silicone between crosslinks is about 20,000 or less. And, for certain embodiments, the number average molecular weight between crosslinks is at least about 500, and often at least about 2000.

The crosslinked silicone is derived from at least one reactive silicone precursor (i.e., base polymer), wherein the silicone precursor includes two or more reactive groups. The reactive groups preferably include epoxy, acrylate, silane, silanol, or ethylenically unsaturated (e.g., vinyl or hexenyl) groups. The silicone precursors that include two or more epoxy or acrylate groups will typically homopolymerize without the need for a separate crosslinker. The silicone precursors that include two or more, silanol, or ethylenically unsaturated groups use a separate crosslinker, such as a hydride-functional silicone crosslinker. Alternatively, a silanol, alkoxylsilane, or acyloxysilane-functional silicone precursor can be reacted with an alkoxy functional crosslinker, as described in U.S. Pat. No. 6,204,350.

Suitable epoxy-functional silicone precursors are described, for example, in U.S. Pat. Nos. 4,279,717 and 5,332,797. Examples of epoxy-functional silicone precursors include, for example, those available under the trade designations SilForce UV 9400, SilForce UV 9315, SilForce UV 9430, SilForce UV 9600, all available from Momentive, Columbus, Ohio, and SILCOLEASE UV200 Series, available from Bluestar Silicones, East Brunswick, N.J.

Suitable acrylate-functional silicone precursors are described, for example, in U.S. Pat. No. 4,348,454. Examples of acrylate-functional silicone precursors include, for example, those available under the trade designation SILCOLEASE UV100 Series, from Bluestar Silicones, and those available under the trade designation TEGO RC 902, TEGO RC 922, and TEGO RC 711, from Evonik Industries, Parsippany, N.J.

Suitable silanol-functional silicone polymers are well known and are available from a variety of sources, including, e.g., those from Gelest, Inc., Morrisville, Pa., available under the trade designation DMS-S12 and DMS-521.

Suitable ethylenically unsaturated functional silicone precursors include polydimethysiloxanes with pendant and/or terminal vinyl groups, as well as polydimethylsiloxanes with pendant and/or terminal hexenyl groups. Suitable hexenyl functional silicones are described, for example, in U.S. Pat. No. 4,609,574. An example of a hexenyl functional silicone includes, for example, one available under the trade designation SYL-OFF 7677, available from Dow Corning, Midland Mich. Suitable vinyl-functional silicones are described, for example, in U.S. Pat. No. 3,814,731 and U.S. Pat. No. 4,162,356, and are available from a wide variety of sources. Examples of vinyl terminated polydimethsiloxane include those available under the trade designations DMS-V21 (molecular weight=6000) and DMS-V25 (molecular weight=17,200), from Gelest Inc. Suitable vinyl-functional silicone polymers are also available under the trade name SYL-OFF from Dow Corning. An exemplary material containing end-blocked and pendant vinyl-functional silicone polymers is SYL-OFF 7680-020 polymer from Dow Corning.

Suitable hydride-functional silicone crosslinkers are described, for example, in U.S. Pat. Nos. 3,814,731 and 4,162,356. Suitable crosslinkers are well known, and one of ordinary skill in the art would be readily able to select an appropriate crosslinker, including identifying appropriate functional groups on such crosslinkers, for use with a wide variety of base polymers. For example, hydride-functional crosslinkers are available under the trade designation SYL-OFF from Dow Corning, including those available under the trade designation SYL-OFF 7048 and SYL-OFF 7678. Other exemplary hydride-functional crosslinkers include those available under the trade designation SS4300C and SL4320, available from Momentive Performance Materials, Albany, N.Y.

The hydride equivalent weight of a hydride-functional silicone crosslinker is typically at least about 60, and typically no greater than about 150.

In certain embodiments of the system including a silanol-functional silicone precursor and a hydride functional crosslinker, the ratio of hydride groups to silanol groups is preferably at least about 1.0 (1:1) and often no more than about 25.0 (25:1).

In certain embodiments of the system including an ethylenically unsaturated functional silicone precursor and a hydride functional crosslinker, the ratio of hydride groups to ethylencially unsaturated groups is preferably at least about 1.0 (1:1), and more preferably at least about 1.1. Often, the ratio is no more than about 2.0 (2:1) and more often no more than about 1.5.

Suitable alkoxy-functional crosslinkers, and conditions of crosslinking, including relative amounts of crosslinker, are described in U.S. Pat. No. 6,204,350.

As mentioned above, the use of high crosslink density results in a release coating having a high COF. The addition of a small amount of a high molecular weight silicone gum can lower the COF. In certain embodiments, at least one reactive silicone precursor is a reactive silicone polydimethylsiloxane additive having one or more functional groups comprising of at least one type of reactive group. The use of such additives can lower the COF of the release liner, if desired. Such reactive silicone additives preferably have a number average molecular weight of at least about 150,000, more preferably at least about 250,000, and are typically described as gums. Preferably, the reactive group or groups on the gum include silanol or ethylenically unsaturated groups (e.g., hexenyl or vinyl groups).

Examples of silanol functional polydimethsiloxane gums include, but are not limited to, those available under the trade designation SS 4191A from Momentive Performance Materials.

Gums with ethylenically unsaturated reactive groups will react with the hydride-functional silicone in a system containing silicone precursor containing ethylenically unsaturated groups. Suitable ethylenically unsaturated silicone gums are described, for example, in U.S. Pat. No. 5,520,978. Examples of vinyl terminated polydimethsiloxane gums include that available under the trade designation 4-7033 (Molecular Weight=370,000), from Dow Corning.

A silicone gum, if used, is typically used in an amount of up to 5%, based on the amount of the base polymer (not counting crosslinker).

The crosslinked silicone described herein is typically derived from one or more reactive silicone precursors crosslinked using a catalyst. Examples of suitable catalysts are described, for example, in U.S. Pat. No. 5,520,978. Preferably, the catalyst is a platinum or rhodium catalyst for vinyl and hexenyl functional silicones. Preferably, the catalyst is a tin catalyst for silanol functional silicones. Examples of commercially available platinum catalysts include, but are not limited to, those available under the trade designation SIP6831.2 (a platinum-divinyltetramethyldisiloxane catalyst complex in xylene; 2.1-2.4% platinum concentration), available from Gelest Inc. The amount of Pt is typically about 60 ppm to about 150 ppm.

Other components used in making silicone release material of the present disclosure include, for example, inhibitors e.g., a diallylmaleate inhibitor available under the trade designation SL 6040-D1 01P, from Momentive, MQ resins such as that available under the trade designation SYL-OFF 7210 RELEASE MODIFIER from Dow Corning, and anchorage additives such as that available under the trade designation SYL-OFF 297 available from Dow Corning.

The backing or substrate can be made of a variety of conventional materials, such as, polycoated Kraft paper and plastic films (e.g., PET, PEN, PE, and PP). Usually the backing or substrate is primed in order to increase the anchorage of the silicone coating. Typical priming methods include corona or flame treatment, or coating of a primer onto the substrate. An example of a primer coating for anchorage of silicone to PET film is disclosed in U.S. Pat. No. 5,077,353. In addition, the backing or substrate may contain an anti-static coating in order to prevent electrostatic charging, thereby helping to keep the laminates free of debris. Examples of anti-static coatings include, but are not limited to, vanadium oxide, as described in U.S. Pat. No. 5,637,368). Preferably, the release liner, and hence the backing is optically clear. Prior art teaches that a low COF silicone liner is beneficial for the converting of a soft adhesive (e.g. W02009/A31792A1). Surprisingly, the current inventors have found that a high COF silicone liner is beneficial for converting optically clear adhesives of the present invention.

Methods of preparing release liners (e.g., coating a crosslinked silicone release material onto a backing or substrate) are well known to one of skill in the art, and are further exemplified in the Examples Section.

### Adhesive Compositions and Articles

The present disclosure also includes an adhesive composition, and corresponding article for assembling optical displays. The adhesive composition has desirable flow characteristics that lead to good thick ink-step lamination, short assembly cycle times, and durable laminates. A laminate is defined as including at least a first substrate, a second substrate, and an adhesive positioned between the first and second substrates. The adhesive composition allows for trapped bubbles formed during lamination to easily escape the adhesive matrix and the adhesive substrate interface, resulting in a bubble-free laminate after autoclave treatment. As a result, minimum lamination defects are observed after lamination and autoclave treatment. The combined benefits of good substrate wetting and easy bubble removal enables an efficient lamination process with greatly shortened cycle times. Additionally, the good stress relaxation and substrate adhesion from the adhesive allow for durable bonding of the laminate (e.g., no bubble/delamination after accelerated aging tests). To achieve these effects, the adhesive composition has certain rheological properties, such as low shear storage modulus (G′) and high tan delta values.

Optical materials may be used to fill gaps between optical components or substrates of optical assemblies. Optical assemblies comprising a display panel bonded to an optical substrate may benefit if the gap between the two is filled with an optical material that matches or nearly matches the refractive indices of the panel and the substrate. For example, sunlight and ambient light reflection inherent between a display panel and an outer cover sheet may be reduced. Color gamut and contrast of the display panel can be improved under ambient conditions. Optical assemblies having a filled gap can also exhibit improved shock-resistance compared to the same assemblies having an air gap.

An optical assembly having a large size or area can be difficult to manufacture, especially if efficiency and stringent optical quality are desired. A gap between optical components may be filled by pouring or injecting a curable composition into the gap followed by curing the composition to bond the components together. However, these commonly used compositions have long flow-out times which contribute to inefficient manufacturing methods for large optical assemblies.

The optically clear adhesive may be used in transfer tape format to fill the air gap between the display substrates. In this process, the liquid adhesive composition precursor of this invention can be applied between two siliconized release liners, at least one of which is transparent to UV radiation that is useful for curing. The adhesive composition can then be cured (polymerized) by exposure to actinic radiation at a wavelength at least partially absorbed by a photoinitiator contained therein. Alternatively, a thermally activated free-radical initiator may be used, where the liquid adhesive composition of this invention can be coated between two siliconized release liners and exposed to heat to complete the polymerization of the composition. A transfer tape that includes a pressure-sensitive adhesive can be thus formed. The formation of a transfer tape can reduce stress in the adhesive by allowing the cured adhesive to relax prior to lamination. For example, in a typical assembly process, one of the release liners of the transfer tape can be removed and the adhesive can be applied to the display assembly. Then, the second release liner can be removed and lamination to the substrate can be completed. When the substrate and the display panel are rigid adhesive bonding can be assisted with vacuum lamination equipment to assure that bubbles are not formed in the adhesive or at the interfaces between the adhesive and the substrate or display panel. Finally, the assembled display components can be submitted to an autoclave step to finalize the bond and make the optical assembly free of lamination defects.

When the cured adhesive transfer tape is laminated between a printed lens and a second display substrate, prevention of optical defects can be even more challenging because the fully cured adhesive may have to conform to a sometimes large ink step (i.e., 50-70 μm) and the total adhesive thickness acceptable in the display may only be 150-250 μm. Completely wetting this large ink step during initial assembly (for example, when printed lens is laminated to the second substrate with the optically clear adhesive transfer tape of this invention) is very important, because any trapped air bubbles may become very difficult to remove in the subsequent display assembly steps. The optically clear adhesive transfer tape needs to have sufficient compliance (for example, low shear storage modulus, G′, at lamination temperature, typically 25° C., of <10e5 Pascal (Pa) when measured at 1 Hz frequency) to enable good ink wetting, by being able to deform quickly, and to comply to the sharp edge of the ink step contour. The adhesive of the transfer tape also has to have sufficient flow to not only comply with the ink step but also wet more completely to the ink surface. The flow of the adhesive can be reflected in the high tan delta value of the material over a broad range of temperatures (i.e., tan δ>0.5 between the glass transition temperature (Tg) of the adhesive (measured by DMTA) and about 50° C. or slightly higher). The stress caused by the rapid deformation of the optically clear adhesive tape by the ink step requires the adhesive to respond much faster than the common stress caused by a coefficient of thermal expansion mismatch, such as in polarizer attachment applications where the stress can be relieved over hours instead of seconds or shorter. However, even those adhesives that can achieve this initial ink step wetting may still have too much elastic contribution from the bulk rheology and this can cause the bonded components to distort, which is not acceptable. Even if these display components are dimensionally stable, the stored elastic energy (due to the rapid deformation of the adhesive over the ink step) may find a way to relieve itself by constantly exercising stress on the adhesive, eventually causing failure. Thus, as in the case of liquid bonding of the display components, the design of a transfer tape to successfully bond the display components requires a delicate balance of adhesion, optics, drop test tolerance, as well as compliance to high ink steps, and good flow even when the ink step pushes into the adhesive layer up to as much as 30% or more of its thickness.

The adhesive composition generally includes at least one alkyl(meth)acrylate ester, wherein the alkyl group has 1 to 18 carbon atoms (preferably 4 to 18 carbon atoms), at least one hydrophilic copolymerizable monomer and a free-radical generating initiator. The adhesive composition may also optionally include a molecular weight control agent, a cross-linker and/or a coupling agent.

Useful alkyl acrylates (i.e., acrylic acid alkyl ester monomers) include, but are not limited to, linear or branched monofunctional acrylates or methacrylates of non-tertiary alkyl alcohols, the alkyl groups of which have from 1 to 18 carbon atoms (preferably 4 to 18 carbon atoms), and in particular, from 1 to 12 carbon atoms. Examples of suitable monomers include, but are not limited to: 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate, n-butyl (meth)acrylate, methyl (meth)acrylate, isobutyl (meth)acrylate, hexyl (meth)acrylate, n-nonyl (meth)acrylate, isoamyl (meth)acrylate, n-decyl (meth)acrylate, isodecyl (meth)acrylate, dodecyl (meth)acrylate, isobornyl (meth)acrylate, cyclohexyl (meth)acrylate, phenyl meth(acrylate), benzyl meth(acrylate), isostearylacrylate and 2-methylbutyl (meth)acrylate, and combinations thereof. Examples of suitable alkyl(meth)acrylate esters include, but are not limited to: 2-ethylhexyl acrylate (2-EHA), isobornyl acrylate (IBA), iso-octylacrylate (IOA) and butyl acrylate (BA). The low Tg yielding acrylates, such as IOA, 2-EHA, and BA provide tack to the adhesive, while the high Tg yielding monomers like IBA allow for the adjustment of the Tg of the adhesive composition without introducing polar monomers. An acrylate is considered as yielding a low Tg if the Tg of its homopolymer is between about −70° C. and about 20° C. An acrylate is considered as yielding a high Tg if the Tg of its homopolymer is between about 20° C. and about 200° C. Another example of a high Tg yielding monomer includes VeOVA 9, a commercially available vinyl ester (available from Momentive Specialty Chemicals, USA). Another useful high Tg yielding monomer is N-t-octylacrylamide.

Examples of suitable hydrophilic copolymerizable monomers include, but are not limited to: acrylic acid (AA), methacrylic acid, itaconic acid, fumaric acid, methacrylamide, N-alkyl substituted and N,N-dialkyl substituted acrylamides or methacrylamides where the alkyl group has up to 3 carbons (e.g., N-tert-ocylacrylamide and N,N-dimethyl acrylamide), 2-hydroxyethyl acrylate (HEA), 2-hydroxy-propyl acrylate (HPA), 3-hydroxypropyl acrylate, 4-hydroxybutylacrylate, 2-ethoxyethoxyethyl acrylate (Viscoat-190), 2-methoxyethoxyethylacrylate, acrylamide (Acm), N-morpholino acrylate (MoA), and diacetoneacrylamide. These monomers often also promote adhesion to the substrates encountered in display assembly. In one embodiment, the adhesive composition includes between (when “between” two numbers is used, this includes the endpoints) about 55 (and preferably about 60) to about 95 parts of the alkyl(methyl)acrylate ester, wherein the alkyl group has 1 to 18 (preferably 4 to 18) carbon atoms, and between about 5 and about 45 parts of the hydrophilic copolymerizable monomer. Particularly, the adhesive composition includes between about 65 to about 95 parts of the alkyl(methyl)acrylate ester, wherein the alkyl group has 1 to 18 carbon atoms (preferably 4 to 18), and between about 5 and about 35 parts of the hydrophilic copolymerizable monomer. Combinations of polar monomers and the hydrophilic, hydroxyl functional monomeric compound may also be used. Examples of hydroxyl functional (meth)acrylate monomers include 2-hydroxyethyl acrylate (HEA) and methacrylate, 2-hydroxypropyl acrylate (HPA) and methacrylate, 3-hydroxypropyl acrylate and methacrylate, 4-hydroxybutyl acrylate and methacrylate, 2-hydroxyethyl acrylamide and 2-hydroxyethyl methacrylamide, and N-hydroxypropyl acrylamide and N-hydroxypropyl methacrylamide. Examples of polar monomers that are not hydroxyl functional monomers, include, for example, acrylic acid, methacrylic acid, itaconic acid, fumaric acid, acrylamide, methacrylamide, N-alkyl and N,N-dialkyl substituted acrylamide and methacrylamides such as N-tert-octylacrylamide, N-tert-octyl methacrylamide, N,N-dimethylacrylamide, and N,N-dimethyl methacrylamide, other substituted (meth)acrylamides such as diacetone acrylamide, as well as cyclic acrylamides such as N-vinyl lactams, N-vinyl lactones, including, for example, N-morpholino acrylate, and the like. Combinations of these types of monomers allow for adhesive compositions with good cohesive strength due to internal hydrogen bonding between the polar monomer and the hydrophilic, hydroxyl functional monomeric compound. These compositions may also have a broadened glass transition temperature (Tg), which in turn may broaden the lamination window for the adhesive composition.

In certain embodiments of adhesive compositions that include hydroxyl functional monomers and polar monomers other than hydroxyl functional monomers, the hydroxyl functional monomers are present in an amount of between (including endpoints) about 10 to about 40 parts, and preferably about 10 to about 25 parts, and in some embodiments about 10 to about 20 parts, based on the acrylic composition of the transfer adhesive. Examples of hydroxyl functional monomers include hydroxyl functional (meth)acrylate or (meth)acrylamide monomers as listed above. Preferred hydroxyl functional monomers include 2-hydroxyethyl acrylate. Combinations of hydroxyl functional monomers may also be used.

In certain embodiments of adhesive compositions that include hydroxyl functional monomers and polar monomers other than hydroxyl functional monomers, the polar monomers are (meth)acrylamide monomers, and preferably non-cyclic (meth)acrylamide monomers. These are present in an amount of between about 5 to about 20 parts, and preferably about 7 to about 20 parts, in some embodiments about 5 to about 10 parts (e.g., for (meth)acrylamide) and in other embodiments about 10 to about 20 parts (e.g., for substituted (meth)acrylamides), based on the acrylic composition of the transfer adhesive. Examples of preferred (meth)acrylamide monomers include acrylamide, methacrylamide, N-substituted (meth)acrylamides such as N-alkyl and N,N-dialkyl substituted acrylamides and methacrylamides, including, for example diacetone acrylamide, N-t-octylacrylamide, and the like. Combinations of polar monomers may also be used.

In certain embodiments of adhesive compositions that include hydroxyl functional monomers and polar monomers other than hydroxyl functional monomers, the compositions also include alkyl(methyl)acrylate esters, wherein the alkyl group has 1 to 18 (preferably 4 to 18) carbon atoms, as described above, and preferably non-cyclic alkyl(meth)acrylate monomers. These are present in an amount of between about 55 to about 95 parts, for certain embodiments about 60 to about 95 parts, and for certain embodiments about 55 to about 85 parts, and in some embodiments about 60 to about 80 parts. Examples of preferred non-cyclic alkyl (meth)acrylate monomers include 2-EHA and IOA. Combinations of alkyl(meth)acrylate monomers may also be used.

In certain embodiments of adhesive compositions that include hydroxyl functional monomers and polar monomers other than hydroxyl functional monomers, the compositions also may optionally include a crosslinker, preferably in an amount of less than 0.1 part, based on the acrylic composition of the transfer adhesive.

In certain embodiments of adhesive compositions that include hydroxyl functional monomers and polar monomers other than hydroxyl functional monomers, the adhesive compositions are preferably pressure sensitive adhesives, are not removable, do not include microparticles, and have no pendant unsaturation.

In one embodiment, the adhesive composition may include an acrylic oligomer. The acrylic oligomer can be a substantially water-insoluble acrylic oligomer derived from (methacrylate monomers). In general, (meth)acrylate refers to both acrylate and methacrylate functionality.

The acrylic oligomer can be used to control the viscous to elastic balance of the cured composition of the invention and the oligomer contributes mainly to the viscous component of the rheology. In order for the acrylic oligomer to contribute to the viscous rheology component of the cured composition, the (meth)acrylic monomers used in the acrylic oligomer can be chosen in such a way that glass transition of the oligomer is below 25° C., typically below 0° C. The oligomer can made from (meth)acrylic monomers and can have a weight average molecular weight (Mw) of at least 1,000, typically 2,000. It should not exceed the entanglement molecular weight (Me) of the oligomer composition. If the molecular weight is too low, out gassing and migration of the component can be problematic. If the molecular weight of the oligomer exceeds Me, the resulting entanglements can contribute to a less desirable elastic contribution to the rheology of the adhesive composition. Mw can be determined by GPC. Me can be determined by measuring the viscosity of the pure material as a function of molecular weight. By plotting the zero shear viscosity versus molecular weight in a log/log plot the point of change in slope corresponds to as the entanglement molecular weight. Above the Me the slope will increase significantly due to the entanglement interaction. Alternatively, for a given monomer composition, Me can also be determined form the rubbery plateau modulus value of the polymer in dynamic mechanical analysis provided we know the polymer density as is known by those of ordinary skill in the art. The general Ferry equation G₀=rRT/Me provides a relationship between Me and the modulus G₀. Typical entanglement molecular weights for (meth)acrylic polymers are on the order of 10,000-60,000, and in some embodiments 30,000-60,000. The acrylic oligomer can include a substantially water-insoluble acrylic oligomer derived from (meth)acrylate monomers. Substantially water-insoluble acrylic oligomer derived from (meth)acrylate monomers are well known and are typically used in urethane coatings technology. Due to their ease of use, favorable acrylic oligomers include liquid acrylic oligomer derived from (meth)acrylate monomers. The liquid acrylic oligomer derived from (meth)acrylate monomers can have a number average molecular weight (Mn) within the range of about 500 to about 10,000. Commercially available liquid acrylic oligomers also have a hydroxyl number of from about 20 mg KOH/g to about 500 mg KOH/g, and a glass transition temperature (Tg) of about −70° C. These liquid acrylic oligomers derived from (meth)acrylate monomers typically comprise recurring units of a hydroxyl functional monomer. The hydroxyl functional monomer is used in an amount sufficient to give the acrylic oligomer the desired hydroxyl number and solubility parameter. Typically the hydroxyl functional monomer is used in an amount within the range of about 2% to about 60% by weight (wt %) of the liquid acrylic oligomer. Instead of hydroxyl functional monomers, other polar monomers such as acrylic acid, methacrylic acid, itaconic acid, fumaric acid, acrylamide, methacrylamide, N-alkyl and N,N-dialkyl substituted acrylamide and methacrylamides, N-vinyl lactams, N-vinyl lactones, and the like can also be used to control the solubility parameter of the acrylic oligomer. Combinations of these polar monomers may also be used. The liquid acrylic oligomer derived from acrylate and (meth)acrylate monomers also typically comprises recurring units of one or more C1 to C20 alkyl (meth)acrylates whose homopolymers have a Tg below 25° C. It is important to select a (meth)acrylate that has low homopolymer Tg because otherwise the liquid acrylic oligomer can have a high Tg and may not stay liquid at room temperature. However, the acrylic oligomer does not always need to be a liquid, provided it can readily be solubilized in the balance of the adhesive composition used in this invention. Examples of suitable commercial (meth)acrylates include n-butyl acrylate, n-butyl methacrylate, lauryl acrylate, lauryl methacrylate, isooctyl acrylate, isononylacrylate, isodecylacrylate, tridecyl acrylate, tridecyl methacrylate, 2-ethylhexyl acrylate, 2-ethylhexyl methacrylate, and mixtures thereof. The proportion of recurring units of C1 to C20 alkyl acrylates or methacrylates in the acrylic oligomer derived from acrylate and methacrylate monomers depends on many factors, but most important among these are the desired solubility parameter and Tg of the resulting adhesive composition. Typically liquid acrylic oligomer derived from acrylate and methacrylate monomers can be derived from about 40% to about 98% alkyl (meth)acrylate monomers.

Optionally, the acrylic oligomer derived from (meth)acrylate monomers can incorporate additional monomers. The additional monomers can be selected from vinyl aromatics, vinyl halides, vinyl ethers, vinyl esters, unsaturated nitriles, conjugated dienes, and mixtures thereof. Incorporation of additional monomers may reduce raw material cost or modify the acrylic oligomer properties. For example, incorporating styrene or vinylacetate into the acrylic oligomer can reduce the cost of the acrylic oligomer.

Suitable liquid acrylic oligomers include copolymers of n-butyl acrylate and allyl monopropoxylate, n-butyl acrylate and allyl alcohol, n-butyl acrylate and 2-hydroxyethyl acrylate, n-butyl acrylate and 2-hydroxy-propyl acrylate, 3-hydroxypropyl acrylate, 2-ethylhexyl acrylate and allyl propoxylate, 2-ethylhexyl acrylate and 2-hydroxy-propyl acrylate, and the like, and mixtures thereof. Exemplary acrylic oligomers useful in the provided optical assembly are disclosed, for example, in U.S. Pat. No. 6,294,607 (Guo et al.) and U.S. Pat. No. 7,465,493 (Lu), as well as acrylic oligomer derived from acrylate and methacrylate monomers having the trade name JONCRYL (available from BASF, Mount Olive, N.J.) and ARUFON (available from Toagosei Co., Lt., Tokyo, Japan).

It is also possible to make the provided acrylic oligomers in-situ. For example, if on-web polymerization is used, a monomer composition may be prepolymerized by UV or thermally induced reaction. The reaction can be carried out in the presence of a molecular weight control agent, like a chain-transfer agent, such as a mercaptan, or a retarding agent such as, for example, styrene, α-methyl styrene, α-methyl styrene dimer, to control chain-length and molecular weight of the polymerizing material. For example, when the control agent is completely consumed, the reaction can proceed to higher molecular weights and thus a true high molecular weight polymer will form. Likewise, the polymerization conditions for the first step of the reaction can be chosen in such a way that only oligomerization happens, followed by a change in polymerization conditions that yields high molecular weight polymer. For example, UV polymerization under high intensity light can result in lower chain-length growth where polymerization under lower light intensity can give higher molecular weight. In one embodiment, the molecular weight control agent is present at between about 0.025% and about 1%, and particularly between about 0.05% and about 0.5% of the composition.

To further optimize adhesive performance of the optically clear adhesive, adhesion promoting additives, such as silanes and titanates may also be incorporated into the optically clear adhesives of the present disclosure. Such additives can promote adhesion between the adhesive and the substrates, like the glass and cellulose triacetate of an LCD by coupling to the silanol, hydroxyl, or other reactive groups in the substrate. The silanes and titanates may have only alkoxy substitution on the Si or Ti atom connected to an adhesive copolymerizable or interactive group. Alternatively, the silanes and titanates may have both alkyl and alkoxy substitution on the Si or Ti atom connected to an adhesive copolymerizable or interactive group. The adhesive copolymerizable group is generally an acrylate or methacrylate group, but vinyl and allyl groups may also be used. Alternatively, the silanes or titanates may also react with functional groups in the adhesive, such as a hydroxyalkyl(meth)acrylate. In addition, the silane or titanate may have one or more group providing strong interaction with the adhesive matrix. Examples of this strong interaction include, hydrogen bonding, ionic interaction, and acid-base interaction. An example of a suitable silane includes, but is not limited to, (3-glycidyloxypropyl)trimethoxysilane.

The pressure sensitive adhesive can be inherently tacky. If desired, tackifiers can be added to the precursor mixture before formation of the pressure sensitive adhesive. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Other materials can be added for special purposes, including, for example, oils, plasticizers, antioxidants, UV stabilizers, pigments, curing agents, polymer additives, and other additives provided that they do not significantly reduce the optical clarity of the pressure sensitive adhesive.

The adhesive compositions may have additional components added to the precursor mixture. For example, the mixture may include a multifunctional crosslinker. Such crosslinkers include thermal crosslinkers which are activated during the drying step of preparing solvent coated adhesives and crosslinkers that copolymerize during the polymerization step. Such thermal crosslinkers may include multifunctional isocyanates, aziridines, multifunctional (meth)acrylates, and epoxy compounds. Exemplary crosslinkers include difunctional acrylates such as 1,6-hexanediol diacrylate or multifunctional acrylates such as are known to those of skill in the art. Useful isocyanate crosslinkers include, for example, an aromatic diisocyanate available as DESMODUR L-75 from Bayer, Cologne, Germany Ultraviolet, or “UV”, activated crosslinkers can also be used to crosslink the pressure sensitive adhesive. Such UV crosslinkers may include non-copolymerizable photocrosslinkers, such as benzophenones and copolymerizable photocrosslinkers such as acrylated or methacrylate benzophenones like 4-acryloxybenzophenones.

In addition, the precursor mixtures for the provided adhesive compositions can include a thermal or a photoinitiator. Examples of thermal initiators include peroxides such as benzoyl peroxide and its derivatives or azo compounds such as VAZO 67, available from E. I. du Pont de Nemours and Co. Wilmington, Del., which is 2,2′-azobis-(2-methylbutyronitrile), or V-601, available from Wako Specialty Chemicals, Richmond, Va., which is dimethyl-2,2′-azobisisobutyrate. A variety of peroxide or azo compounds are available that can be used to initiate thermal polymerization at a wide variety of temperatures. The precursor mixtures can include a photoinitiator. Particularly useful are initiators such as IRGACURE 651, available from BASF, Tarrytown, N.Y., which is 2,2-dimethoxy-2-phenylacetophenone. Typically, the crosslinker, if present, is added to the precursor mixtures in an amount of from about 0.025 (and in certain embodiments 0.05) parts by weight to about 5.00 parts by weight based upon the other constituents in the mixture. The initiators are typically added to the precursor mixtures in the amount of from 0.05 parts by weight to about 2 parts by weight. In certain embodiments, the crossliner is present in an amount of less than 0.1 part by weight.

The precursor mixture may also include a vinyl ester, and particularly a C₅ to C₁₀ vinyl ester. An example of a commercially available suitable vinyl ester includes, but is not limited to VeOVA 9 available from Momentive Specialty Chemicals, USA.

The adhesive composition components can be blended to form an optically clear mixture. The mixture can be polymerized by exposure to heat or actinic radiation (to decompose initiators in the mixture). This can be done prior to the addition of a cross-linker to form a coatable syrup to which, subsequently, one or more crosslinkers, and additional initiators can be added, the syrup can be coated on a liner, and cured (i.e., cross-linked) by an addition exposure to initiating conditions for the added initiators. Alternatively, the crosslinker and initiators can be added to the monomer mixture and the monomer mixture can be both polymerized and cured in one step. The desired coating viscosity can determine which procedure is used. The disclosed adhesive compositions or precursors may be coated by any variety of known coating techniques such as roll coating, spray coating, knife coating, die coating, and the like. Alternatively, the adhesive precursor composition may also be delivered as a liquid to fill the gap between the two substrates and subsequently be exposed to heat or UV to polymerize and cure the composition.

The cured adhesive composition exhibits elevated tan delta values in the region of about 25° C. and about 100° C. and more particularly in the region of about 50° C. and about 100° C. and often increases with increasing temperatures, resulting in facile lamination by common techniques such as roller lamination or vacuum lamination. Tan delta values indicate the viscous to elastic balance of the adhesive composition. A high tan delta corresponds to a more viscous character and thus, reflects the ability to flow. Generally, a higher tan delta value equates to higher flow properties. The ability of an adhesive to flow during the application/lamination process is a significant factor in the performance of the adhesive in terms of wetting the thick ink step and ease of lamination.

In a typical application of an adhesive composition for rigid-to-rigid (e.g., cover glass to touch sensor glass lamination for use in a phone or tablet device) lamination, the lamination is first carried out at either room or elevated temperature. In one embodiment, lamination is carried out at between about 25° C. and about 75° C. (and in certain embodiments 60° C.). At the lamination temperature, the adhesive composition has a tan delta value of at least about 0.5, and preferably between about 0.5 and about 1.5 (and for certain embodiments, between about 0.5 and about 1.0). When the tan delta value is too low (i.e. below 0.5), initial wet out of the adhesive may be difficult and higher lamination pressure and/or longer press times may be required to achieve good wetting. This may result in longer assembly cycle times and possible distortion of one or more of the display substrates. Likewise, if the tan delta value becomes too high (i.e., >2.0) the adhesive composition may be too soft to resist the lamination pressures and adhesive squeeze-out or oozing may result. Such high tan delta values may also result in storage instability of any die cuts that are derived from such an adhesive. For example oozing may result if stored at room temperature. In one embodiment, the adhesive composition maintains a tan delta value of at least about 0.5, and preferably between about 0.5 and about 1.5 (and for certain embodiments, between about 0.5 and about 1.0) at a temperature of between about 25° C. and about 100° C. and particularly between about 50° C. and about 100° C. In another embodiment, the adhesive composition maintains a tan delta value of between about 0.6 and about 0.8 at a temperature of between about 25° C. and about 100° C. and particularly between about 50° C. and about 100° C.

In a subsequent step, this laminate is then subjected to an autoclave treatment where pressure and potentially heat are applied to remove any trapped bubbles during the rigid-to-rigid lamination process. The better the flow characteristics of the adhesive, the more easily the adhesive can cover thick ink-steps. Furthermore, good adhesive flow allows for the trapped bubbles from the lamination step to easily escape the adhesive matrix or the optically clear adhesive substrate interface, resulting in a bubble-free laminate after the autoclave treatment. Under autoclave temperatures, for example at about 50° C., the adhesive composition maintains a tan delta value of at least about 0.5, preferably between about 0.5 and about 1.5 (and in certain embodiments, between about 0.6 and about 1.0). In particular, the adhesive composition maintains a tan delta value of between about 0.7 and about 1.0. When the tan delta values at typical autoclave temperatures falls below 0.6 the adhesive may not soften fast enough to further wet the substrate and to allow any lamination step entrapped air bubbles to escape. Likewise, if the tan delta value exceeds about 2.0 (and for certain embodiments, about 1.0) at or below about 150° C., the viscous character of the adhesive may be too high and adhesive squeeze-out and oozing may result. Thus the combined benefits of good substrate wetting and easy bubble removal enables an efficient lamination display assembly process with greatly shortened cycle time. In one embodiment, the cycle time for vacuum lamination is less than about 15 seconds and less than about 30 minutes for autoclave treatment.

The ability of the adhesive to flow can be measured using dynamic mechanic thermal analysis (DMTA). Pressure sensitive adhesives (PSAs) are viscoelastic materials. The tan delta value from the DMA measurement is the ratio of the viscous component (shear loss modulus G″) of the PSA to the elastic component (shear storage modulus G′) of the PSA. At temperatures above the glass transition temperature of the PSA, higher tan delta values indicate better adhesive flow.

The tan delta value of the adhesive composition of the present disclosure is preferably at least about 0.5 (and in some embodiments, greater than about 0.5) at room temperature and often exceeds this value as the temperature increases. More particularly, the tan delta can exceed a value of 0.6. Tan delta may also increase as temperature increases. While high tan delta values indicate good flow at process and autoclave process conditions, this has to be counterbalanced against durability of the display. For example, for storage stability, die cutting, and durability, this value cannot be too high or the adhesive may ooze, causing the display to fail. In one embodiment, at a temperature between about 50° C. and about 100° C., the tan delta value is in the range of between about 0.5 and about 1.0, particularly between about 0.6 and about 1.0 and more particularly between about 0.6 and about 0.8. It is expected that tan delta values exceeding a value of about 1 at temperatures required for durability (i.e. 80-90° C.) may be detrimental to durability. This may be critical if the substrates in the display are dimensionally unstable and can warp or expand significantly (i.e. change dimensions by tens of microns). Likewise, values for tan delta exceeding about 1 between about 25° C. and for example the 80-90° C. required for durability, may also require special handling of the product (i.e. refrigeration) during shipping and storage. Adhesives with a tan delta value exceeding 1 in the about 25° C. to about 100° C. range may also be too soft to resist outgassing from substrates such a PMMA or polycarbonate, especially if these substrates have thicknesses on the order of about 1 mm or more, and are free of coatings (such as hard coatings) that may minimize the outgassing towards the optically clear adhesive.

To further improve the durability of the assembled display, the soft adhesive composition of the invention can be further crosslinked after assembly. For example, by exposing the adhesive composition containing a photocrosslinker, the tan delta at elevated temperature (for example 75° C.) can be reduced by crosslinking the adhesive, As such, the balance between viscous and elastic rheological behavior can be shifted towards more elastic character after the assembly process is completed.

The tan delta value of an adhesive composition can be increased by incorporating more viscous properties into the adhesive composition. For example, the adhesive composition may have a higher soluble fraction to counterbalance the elastic portion which is derived from the gel part of the formula. This balance can be shifted by changing molecular weight distribution, curing profile, etc. By controlling the tan delta values of the adhesive composition, desired adhesive flow can be achieved.

The adhesive layers described above can be formed by either thermopolymerization or photopolymerization processes. For example, the liquid composition may be cured using ultraviolet (UV) radiation. The liquid compositions described above are said to be cured using actinic radiation, i.e., radiation that leads to the production of photochemical activity. For example, actinic radiation may comprise radiation of from about 250 nm to about 700 nm. Sources of actinic radiation include tungsten halogen lamps, xenon and mercury arc lamps, incandescent lamps, germicidal lamps, fluorescent lamps, lasers and light emitting diodes. UV-radiation can be supplied using a high intensity continuously emitting system such as those available from Fusion UV Systems. If desired, the curing using actinic radiation may be assisted with heat. Alternatively to UV or visible light induced curing, a heat curing mechanism may be used. To heat cure, thermally activated initiators such as peroxides or azo compounds can be used to substitute for the photo-activated initiators in the composition as is well know by those persons having ordinary skill in the art.

When used in optical assemblies, the adhesive composition is designed to be suitable for optical applications. For example, the adhesive composition may have at least 85% transmission over the range of from 460 to 720 nm. The adhesive composition may have, per millimeter thickness, a transmission of greater than about 85% at 460 nm, greater than about 90% at 530 nm, and greater than about 90% at 670 nm. These transmission characteristics provide for uniform transmission of light across the visible region of the electromagnetic spectrum which is important to maintain the color point in full color displays. Additionally, the adhesive layer typically has a refractive index that matches or closely matches that of the display panel and/or the substantially transparent substrate. For example, the adhesive layer may have a refractive index of from about 1.4 to about 1.7.

The thickness of the adhesive layer in the articles of disclosure tends to be at greater than about 5 micrometers, greater than about 10 micrometers, greater than about 15 micrometers, or even greater than about 20 micrometers. The thickness is often less than about 1000 micrometers, less than about 250 micrometers, less than about 200 micrometers, or even less than about 175 micrometers. For example, the thickness can be from about 5 to about 1000 micrometers, from about 10 to about 500 micrometers, from about 25 to about 250 micrometers, or from about 50 to about 175 micrometers.

In certain embodiments, the adhesive is a cloud point-resistant, optically clear adhesive. For example, a laminate that includes such adhesive has a haze value of less than 5% and an average transmission between 450 nanometers and 650 nanometers of greater than about 85% after it is place in an environment of at least 70° C. and 90% relative humidity for 72 hours, cooled to room temperature, and measured.

In one embodiment, the adhesive composition is used in an optical assembly that includes a display panel. The display panel can include any type of panel such as a liquid crystal display panel. Liquid crystal display panels are well known and typically include a liquid crystal material disposed between two substantially transparent substrates such as glass or polymer substrates. As used herein, substantially transparent refers to a substrate that is suitable for optical applications, e.g., has at least 85% transmission over the range of from 460 to 720 nm. Optical substrates can have, per millimeter thickness, a transmission of greater than about 85% at 460 nm, greater than about 90% at 530 nm, and greater than about 90% at 670 nm. Transparent electrically conductive materials that function as electrodes can be present on the inner surfaces of the substantially transparent substrates. In some cases, on the outer surfaces of the substantially transparent substrates can be polarizing films that can pass essentially only one polarization state of light. When a voltage is applied selectively across the electrodes, the liquid crystal material can reorient to modify the polarization state of light, such that an image can be created. The liquid crystal display panel can also comprise a liquid crystal material disposed between a thin film transistor array panel having a plurality of thin film transistors arranged in a matrix pattern and a common electrode panel having a common electrode.

In some other embodiments, the display panel may comprise a plasma display panel. Plasma display panels are well known and typically comprise an inert mixture of noble gases such as neon and xenon disposed in tiny cells located between two glass panels. Control circuitry charges electrodes within the panel can cause the gases to ionize and form a plasma which then can excite phosphors contained therein to emit light.

In other embodiments, the display panel may comprise a light-emitting diode (LED) display panel. Light-emitting diodes can be made using organic or inorganic electroluminescent materials and are well known to those having ordinary skill in the art. These panels are essentially a layer of an electroluminescent material disposed between two conductive glass panels. Organic electroluminescent materials include organic light emitting diodes (OLEDs) or a polymer light emitting diode (PLEDs).

In some embodiments, the display panel may comprise an electrophoretic display. Electrophoretic displays are well known and are typically used in display technology referred to as electronic paper or e-paper. Electrophoretic displays can include a liquid electrically-charged material disposed between two transparent electrode panels. Liquid charged material include nanoparticles, dyes, and charge agents suspended in a nonpolar hydrocarbon, or microcapsules filled with electrically-charged particles suspended in a hydrocarbon material. The microcapsules may also be suspended in a layer of liquid polymer. In some embodiments, the display panel can include a cathode ray tube display.

The provided optical assemblies include a substantially transparent substrate. The substantially transparent substrate can include a glass or a polymer. Useful glasses can include borosilicate, soda lime, and other glasses suitable for use in display applications as protective covers. One particular glass that may be used comprises EAGLE XG and JADE glass substrates available from Corning Inc., Corning N.Y. Useful polymers include polyester films such as polyethylene terephthalate, polycarbonate films or plates, acrylic films such as polymethylmethacrylate films, and cycloolefin polymer films such as ZEONOX and ZEONOR available from Zeon Chemicals (Louisville, Ky.). The substantially transparent substrate typically has an index of refraction close to that of display panel and/or the adhesive layer; for example, from about 1.4 and about 1.7. The substantially transparent substrate typically has a thickness of from about 0.5 mm to about 5 mm.

The provided optical assembly can be touch-sensitive. Touch-sensitive optical assemblies (touch-sensitive panels) can include capacitive sensors, resistive sensors, and projected capacitive sensors. Such sensors include transparent conductive elements on substantially transparent substrates that overlay the display. The conductive elements can be combined with electronic components that can use electrical signals to probe the conductive elements in order to determine the location of an object near or in contact with the display. Touch-sensitive optical assemblies are well known and are disclosed, for example, in U.S. Pat. Publ. Nos. 2009/0073135 (Lin et al.), 2009/0219257 (Frey et al.), and PCT Publ. No. WO 2009/154812 (Frey et al.). Positional touch-sensitive touch panels that include force sensors are also well known and are disclosed, for example, in touch screen display sensors that include force measurement include examples based on strain gauges such as is disclosed in U.S. Pat. No. 5,541,371 (Baller et al.); examples based on capacitance change between conductive traces or electrodes residing on different layers within the sensor, separated by a dielectric material or a dielectric structure comprising a material and air such as is disclosed in U.S. Pat. No. 7,148,882 (Kamrath et al.) and U.S. Pat. No. 7,538,760 (Hotelling et al.); examples based on resistance change between conductive traces residing on different layers within the sensor, separated by a piezoresistive composite material such as is disclosed in U.S. Pat. Publ. No. 2009/0237374 (Li et al.); and examples based on polarization development between conductive traces residing on different layers within the sensor, separated by a piezoelectric material such as is disclosed in U.S. Pat. Publ. No. 2009/0309616 (Klinghult et al.).

### EXAMPLES

Objects and advantages of this disclosure are further illustrated by the following examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight. These abbreviations are used in the following examples: g=grams, min=minutes, hr=hour, mL=milliliter, L=liter.

Materials

| Abbreviation | |
|---|---|
| or | |
| Trade Name | Description |
| 3 SAB | PET film, available under the trade designation |
| | “HOSTAPHAN 3SAB” from Mitsubishi Polyester Film, |
| | GmbH., Greer, South Carolina. |
| 8k divinyl | See “Preparation of |
| silicone | (H₂C═CH)Me₂SiO—(SiMe₂O)₁₀₅—SiMe₂(CH═CH₂)”, |
| | below. |
| Silmer | Linear di-functional silicone pre-polymer with reactive |
| VIN70 | vinyl terminal end groups having a molecular weight of |
| | 3900, available under the trade designation “SILMER |
| | VIN 70” from Siltech Corporation, Toronto, Ontario |
| | Canada. |
| SL6040 | Diallyl maleate inhibitor, available under the trade |
| | designation “SILFORCE SL6040” from Momentive |
| | Performance Materials, Inc., Albany N.Y. |
| SIP6831.2 | Platinum-Divinyltetramethyl-Disiloxane complex in xylene |
| | (2.25% Pt), available from Gelest, Inc., Morrisville, PA. |
| SO7048 | Hydride functional crosslinker, available under the trade |
| | designation “SYL-OFF 7048” from Dow Corning, Midland, |
| | MI |
| SO7678 | Hydride functional crosslinker, available “under the trade |
| | designation SYL-OFF 7678” from Dow Corning, Midland, |
| | MI |
| Methyl Ethyl | Methyl Ethyl Ketone solvent. Available from Sasol, |
| Ketone | Johannesburg South Africa. |
| n-Heptane | n-Heptane solvent, available from Philips Petroleum |
| | Company, Bartlesville, Oklahoma. |
| Liner A | A 2 mil-thick PET release liner, available under the trade |
| | designation “YL-AS” from Nippa Corporation, Osaka, |
| | Japan. |
| Liner B | A 2 mil-thick PET release liner, available under the trade |
| | designation “KF-AS” from Fujimori Kogyo Co. Ltd., |
| | Tokyo, Japan |
| CEF2210 | A contrast enhancement film available under the trade |
| | designation “3M CONTRAST ENHANCEMENT FILM |
| | CEF2210”, from 3M Company, St. Paul, Minnesota. |
| CEF2507 | A contrast enhancement film available under the trade |
| | designation “3M CONTRAST ENHANCEMENT FILM |
| | CEF2507”, from 3M Company. |
| IOA | Isooctyl acrylate, available under the trade designation |
| | “SR440” from Sartomer USA, LLC, Exton, Pennsylvania. |
| 2-EHA | 2-ethylhexyl acrylate, available from Sigma-Aldrich Co. |
| | LLC., St. Louis, Missouri. |
| IBOA | Isobornyl Acrylate, available under the trade designation |
| | “SR506D” from Sartomer USA, LLC. |
| DAAM | Diacetone Acrylamide, available under the product number |
| | “D0062” from TCI America, Portland, Oregon. |
| nVC | n-Vinyl caprolactam, available from Sigma-Aldrich Co. |
| | LLC. |
| ACMO | 4-Acryoylmorpholine, available under the product number |
| | “A0841” from TCI America. |
| tOAcm | N-Tert-octylacryamide, available from Polysciences Inc., |
| | Warrington, Pennsylvania. |
| Acm | Acrylamide, available from Alfa Aesar, Heysham, England |
| nnDMA | N,N-Dimethylacrylamide, available from Sigma-Aldrich |
| | Co. LLC., St. Louis, Missouri. |
| HEA | Hydroxyethyl acrylate, available from Sigma-Aldrich Co. |
| | LLC., St. Louis, Missouri. |
| HPA | Hydroxypropyl acrylate, available from Sigma-Aldrich Co. |
| | LLC., St. Louis, Missouri. |
| PE1 | Epoxy/UV curing agent, available under the trade |
| | designation “KarenzMT PE1” from ShowaDenko America, |
| | New York, New York. |
| HDDA | 1,6-Hexanediol diacrylate, available from Sigma-Aldrich |
| | Co. LLC., St. Louis, Missouri. |
| D1173 | 2-Hydroxy-2-methylpropiophenone, available under the |
| | product number “H0991” from TCI America. |
| I-651 | 2,2-Dimethoxy-1,2-diphenylethan-1-one, a photoinitiator |
| | available under the trade designation “IRGACURE 651” |
| | from from Ciba Specialty Chemicals, Inc., Basel, |
| | Switzerland. |

### Preparation and Test Methods

Preparation of (H₂C═CH)Me₂SiO—(SiMe₂O)₁₀₅—SiMe₂(CH═CH₂), (8k molecular weight silicone)

In a half-gallon polyethylene bottle, 1680.0 g of octamethylcyclotetrasiloxane (5.644 mol, available from Gelest, Inc., Morrisville, Pa.), 30.2 g of 1,3-divinyltetramethyldisiloxane (0.162 mol, available from Gelest, Inc.), 8.6 g of activated carbon and 1.7 g of concentrated sulfuric acid were combined. The mixture was agitated at room temperature for 24 hours and filtered. Volatiles were separated from the filtrate at 170° C. using a wiped film evaporator to give 1126.3 g of a clear, colorless fluid. ¹H and ²⁹Si NMR analysis of the product indicated a polymer with the average structure (H₂C═CH)Me₂SiO—(SiMe₂O)₁₀₅—SiMe₂(CH═CH₂), corresponding to a vinyl meq wt of 4.00 g.

### Preparation of Liner 1

93.0 g 8K molecular weight silicone (prepare above), 0.192 g SL6040, and 0.511 g SIP6831.2 were mixed in 374 g heptane and 94 g MEK, followed by addition of 2.83 g S07678 crosslinker. The silicone solution was coated onto the primed side of 2 mil 3SAB PET film, using gravure coating with a 200 QCH pattern gravure roll, at a line speed was 90 ft/min (27.4 m/min) The coating was dried and cured in an in-line oven set at 250° F. with a residence time of 20 sec, producing Liner 1. The cured silicone coat weight was 0.4 g/m².

### Preparation of Liner 2

93.0 g Silmer VIN70, 0.195 g SL6040, and 0.519 g SIP6831.2 were mixed in 380 g heptane and 95 g MEK, followed by addition of 2.13 g 507048 crosslinker. The silicone solution was coated onto the primed side of 2 mil Mitsubishi 3SAB PET film using gravure coating with a 200 QCH pattern gravure roll, at a line speed was 90 ft/min (27.4 m/min) The coating was dried and cured in an in-line oven set at 250° F. with a residence time of 20 sec, producing Liner 2. The silicone coat weight was 0.4 g/m².

### Silicone Coat Weight Test

The weight of silicone coats were determined by comparing approximately 3.69 cm diameter circular samples of coated and uncoated substrates using an EDXRF spectrophotometer (obtained from Oxford Instruments, Elk Grove Village, Ill. under trade designation OXFORD LAB X3000).

### Coefficient of Friction (COF) Test:

The COF of the surface of a release liner was determined using a Model SP-2100 Slip/Peel Tester commercially available from IMASS, Inc., Accord, Massachusetts. An approximately 25 cm×15 cm piece of release liner was adhered to the platform of the Slip/Peel Tester with the release coating facing up. Care was taken to insure that the release layer was untouched, uncontaminated, flat, and free of wrinkles. The friction sled was wrapped with 3.2 mm thick medium density foam rubber, commercially available from IMASS Inc. under the trade designation Model SP-I01038. The sled was further modified by wrapping a 2.5 inch (6.35 cm)×2.5 inch (6.35 cm) Schoeller 581b PCK paper, available from Felix Schoeller Specialty Papers, Pulaski, N.Y., around the foam rubber with the glossy side of the paper facing out. The modified sled was placed on the release liner's coated surface, with the glossy side of the 581b PCK paper in contact with the release coating. The sled was affixed to the force transducer of the Slip/Peel Tester with a non-elastic leader. Care was taken to minimize the amount of slack in the leader attached to the sled and the force transducer. The platform of the Slip/Peel Tester was set in motion at a speed of 12 in/min (30.5 cm/min), thereby dragging the friction sled across the release layer surface. The COF is given by the average dragging force divided by the weight of the sled. The COF value was recorded by sliding the friction sled along the machine direction of the release liner. COF data is shown in Table 2.

TABLE 2
Coefficient of Friction Data

| Liner | Liner 1 | Liner 2 | Liner A | Liner B |
|---|---|---|---|---|
| COF | 1.6 | 1.4 | 0.1 | 0.2 |

### Release Force Test:

Two PSAs, PSA1 and PSA2, and five release liners; Liner 1, Liner 2, Liner A, Liner B, and Liner C were used for to prepare a series of Examples and Comparative Examples for release force testing. PSA1 is the PSA from CEF2210. PSA2 is the PSA from CEF2507. PSA 1 was 10 mil (0.254 mm) thick and PSA 2 was 7 mil (0.178 mm) thick. Each construction had an easy release liner and a tight release liner, designated Liner C. Samples were prepared by removing the original easy liner, the liner with the lower release force, and hand laminating the release-coated side of an easy release liner (Liner 1, Liner 2, Liner A or Liner B) to the exposed surface of the PSA. The final construction of the sample was a three-layer structure: an easy release liner, an adhesive layer and a tight release liner. The final PSA sample had dimension of 6.5 inch (16.5 cm)×8.1 inch (20.6 cm), and the easy liner had a dimension of 6.7 inch (17.0 cm)×8.6 inch (21.8 cm) with the easy liner's extended portion evenly distributed around the PSA.

The average release force required to peel a release liner from a PSA was measured using a Model SP-2100 Slip/Peel Tester commercially available from IMASS, Inc., Accord, Massachusettes, at a 180-degree peel angle and a speed of 90 in/min (229 cm/min) When measuring the release force of an “easy” release liner, the tight release liner was mounted on the stage and the release force of the easy liner was measured during the peel test. To measure the release force of Liner C to PSA1, the easy release liner of the PSA as received CEF2210 was removed and the exposed PSA1 was mounted directly to the stage of the Slip/Peel tester. Liner C was then removed during the peel test and the corresponding peel force was measured. A similar test was conducted to measure the release force of liner C from PSA2, using CEF2507 in place of CEF2210. The average release force of the five release liners from the two different PSAs is summarized in Table 2, below. The ratio of the release force of the high release force liner, Liner C (tight release liner), to that of the low release force liners (easy release liners), is also shown in Table 3.

TABLE 3
Release Force Measurement Data

| | | | Release | Release |
|---|---|---|---|---|
| | | Release | force | Force Ratio |
| Example | PSA | Liner | (g/inch) | (High/Low) |
| Comparative | PSA 1 | Liner C | 71 | na |
| Example 1 | (CEF2210) | | | |
| Example 2 | PSA1 | Liner 1 | 28 | 2.5 |
| Example 3 | PSA1 | Liner 2 | 26 | 2.7 |
| Comparative | PSA1 | Liner A | 16 | 4.4 |
| Example 4 | | | | |
| Comparative | PSA1 | Liner B | 13 | 5.5 |
| Example 5 | | | | |
| Comparative | PSA2 | Liner C | 44 | na |
| Example 6 | (CEF2507) | | | |
| Example 7 | PSA2 | Liner 1 | 26 | 1.7 |
| Example 8 | PSA2 | Liner 2 | 23 | 1.9 |
| Comparative | PSA2 | Liner A | 15 | 2.9 |
| Example 9 | | | | |
| Comparative | PSA2 | Liner B | 13 | 3.4 |
| Example 10 | | | | |

### Release Liner Failure Test:

Samples were prepared as described for the Release Force Test. Test samples were stored at room temperature for 14 days before being tested. The release liner failure test was conducted by attaching a 3-layer PSA sample onto a vacuum stage. The vacuum stage is constructed using a PET mesh with a mesh count of 137 and tension at 34 N/m, available from Northwest Graphic Supply Company, Minneapolis Minn., A negative pressure, 4.5 kPa, was generated with a 5HP RIGID portable shopvac, available from The Home Depot. The samples were fixed onto the vacuum stage with the tight release liner adjacent the vacuum stage. A piece of tape, available under the trade designation 3M MAGIC TAPE 810 from 3M Company, St. Paul, Minn., about 1 cm×2 cm was attached to the corner of the easy release liner that extends outside the PSA, see FIG. 2a. The release liner was removed manually by pulling the adhesive tape at a 90° angle, to initiate the liner removal, followed by a 135° peel at approx 90 in/min speed (229 cm/min). The removal of the easy liner occurred diagonally across the adhesive sample, see FIG. 2b. Care was taken to ensure a constant peel angle and peel speed. A release liner was considered to fail the test if any of the following criteria was met: a) irrecoverable bending of sample when the easy liner is removed which results in leakage of vacuum; b) detachment of PSA sample from the vacuum stage because of vacuum leakage; c) separation of PSA from the tight liner when the easy liner is removed; d) irrecoverable shift of PSA sample's position on the vacuum stage during the process of removing the easy liner; or e) adhesive deformation along the edges when the release liner is removed. An irrecoverable optical defect occurs to the adhesive sample if any one or a combination of the failure modes are observed. Results from the Release Liner Failure Test are shown in Table 4. As can be seen in Table 4, the release liners that had a high COF, Liner 1 and Liner 2, have a much lower failure level compared to those that have a low COF, Liner A and Liner B.

TABLE 4
Release Liner Failure Data

| | | Release | # of Sample | Failure |
|---|---|---|---|---|
| Example | PSA | Liner | Tested | (%) |
| Example 2 | PSA 1 | Liner 1 | 20 | 20 |
| Example 3 | PSA 1 | Liner 2 | 20 | 10 |
| Comparative | PSA 1 | Liner A | 20 | 60 |
| Example 4 | | | | |
| Comparative | PSA 1 | Liner B | 20 | 90 |
| Example 5 | | | | |
| Example 7 | PSA2 | Liner 1 | 20 | 20 |
| Example 8 | PSA2 | Liner 2 | 20 | 30 |
| Comparative | PSA2 | Liner A | 20 | 70 |
| Example 9 | | | | |
| Comparative | PSA2 | Liner B | 20 | 80 |
| Example 10 | | | | |

### Pressure Sensitive Adhesive (PSA) Preparation:

A representative preparation is described for PSA Example 11. 20.4 g of 2EHA, 1.2 g of DAAM, 2.4 g of IBOA, 6 g of HEA and 0.09 g of D1173 were mixed in a clear vial for 30 minutes. The vial was purged with nitrogen for 3 minutes and then irradiated with UV light (0.5 mW/cm²) until the viscosity significantly increased, i.e. a syrup was formed, at which time the UV light was turned off. To the syrup, 0.09 g of PE1, 0.03 g of HDDA, and 0.06 g of 1-651 were added and mixed until dissolved. The syrup was then coated between two 2 mil thick conventional release liners, one liner was a “tight” release liner and the other was an “easy’ release liner, using a knife coater with a gap set to yield a syrup coating thickness of 10 mils. This construction was then irradiated with UV black light to give a total dose of 1,000 mJ/cm². PSA Examples 12-21 and PSA Comparative Examples, CE22-CE25, were generated using the procedure described for Example 1, with the corresponding formulations and amounts as shown in Table 5, below.

TABLE 5
Formulations for PSA Examples 11-21 and Comparative Examples 22-25

| PSA | | | | | | | | | | | | | | |
|---|---|---|---|---|---|---|---|---|---|---|---|---|---|---|
| Example | 2EHA | DAAM | Acm | NVC | ACMO | IBOA | HEA | HPA | ToAcm | nnDMA | D1173 | PE1 | HDDA | I651 |
| 11 | 20.4 | 1.2 | | | | 2.4 | 6 | | | | 0.006 | 0.09 | 0.03 | 0.06 |
| 12 | 20.4 | 2.4 | | | | 1.2 | 6 | | | | 0.006 | 0.09 | 0.03 | 0.06 |
| 13 | 20.4 | 3.6 | | | | | 6 | | | | 0.006 | 0.09 | 0.03 | 0.06 |
| 14 | 19.2 | 4.8 | | | | | 6 | | | | 0.006 | 0.09 | 0.03 | 0.06 |
| 15 | 20.4 | | | | 3.6 | | 6 | | | | 0.006 | 0.09 | 0.03 | 0.06 |
| 16 | 20.4 | | | 3.6 | | | 6 | | | | 0.006 | 0.09 | 0.03 | 0.06 |
| 17 | 23.1 | | 0.9 | | | | | 6 | | | 0.006 | 0.09 | 0.03 | 0.06 |
| 18 | 23.4 | 3.6 | | | | | 3 | | | | 0.006 | 0.09 | 0.03 | 0.06 |
| 19 | 20.4 | | | | | | 6 | | 3.6 | | 0.006 | 0.09 | 0.03 | 0.06 |
| 20 | 20.4 | | | | | | 6 | | | 3.6 | 0.006 | 0.09 | 0.03 | 0.06 |
| 21 | 20.4 | 3.5 | | | | | 5.6 | | | | 0.006 | 0.074 | 0.022 | 0.06 |
| CE22 | 16.5 | | | | | 7.5 | 6 | | | | 0.006 | 0.09 | 0.03 | 0.06 |
| CE23 | 16.5 | | | | | 7.5 | 6 | | | | 0.006 | 0.09 | 0.06 | 0.06 |
| CE24 | 16.5 | | | | | 7.5 | 6 | | | | 0.006 | 0.09 | 0.09 | 0.06 |
| CE25 | 24 | | | | | | 6 | | | | 0.006 | 0.09 | 0.03 | 0.06 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An adhesive article comprising a release liner having a release layer and at least one adhesive layer adjacent to the release layer;
wherein the release layer comprises a crosslinked silicone polymer and has a coefficient of friction of at least about 0.4; and
wherein the adhesive layer comprises an adhesive composition that maintains a tan delta value of at least about 0.5 at a temperature of between about 25° C. and about 100° C.

2. The adhesive article of claim 1, wherein the release layer has a coefficient of friction of at least about 0.6.

3. (canceled)

4. The adhesive article of claim 1, wherein the crosslinked silicone polymer is derived from at least one reactive silicone precursor, wherein the silicone precursor comprises two or more reactive groups.

5. The adhesive article of claim 4, wherein the reactive groups comprise epoxy, acrylate, silanol, alkoxylsilane, acyloxysilane or ethylenically unsaturated groups.

6. The adhesive article of claim 1, wherein the crosslinked silicone polymer is derived from at least one silicone precursor comprising two or more epoxy or acrylate groups.

7. The adhesive article of claim 1, wherein the crosslinked silicone polymer is derived from at least one silicone precursor comprising two or more silanol or ethylenically unsaturated groups and at least one hydride-functional silicone crosslinker.

8. The adhesive article of claim 4, wherein at least one reactive silicone precursor is a reactive silicone gum comprising at least one type of reactive group.

9. The adhesive article of claim 8, wherein the reactive silicone gum has a number average molecular weight of at least 150,000.

10. The adhesive article of claim 4, wherein the reactive groups comprise silanol or ethylenically unsaturated groups.

11. The adhesive article of claim 8, wherein the reactive silicone gum comprises ethylenically unsaturated groups.

12. (canceled)

13. (canceled)

14. The adhesive article of claim 1, wherein the adhesive composition maintains a tan delta value of between about 0.5 and about 1.5 at a temperature of between about 25° C. and about 100° C.

15. (canceled)

16. (canceled)

17. The adhesive article of claim 1, wherein the adhesive composition is derived from components comprising:
an alkyl (meth)acrylate ester, wherein the alkyl group has 1 to 18 carbon atoms;
a hydrophilic copolymerizable monomer; and
a free-radical generating initiator.

18. The adhesive article of claim 17, wherein the alkyl(meth)acrylate ester is selected from the group consisting of 2-ethylhexyl acrylate (2-EHA), isobornyl acrylate (IBA), iso-octylacrylate (IOA), butyl acrylate (BA), and combinations thereof.

19. The adhesive composition of claim 17, wherein the hydrophilic copolymerizable monomer is selected from the group consisting of acrylic acid (AA), 2-hydroxyethyl acrylate (HEA), hydroxypropyl acrylate (HPA), ethoxyethoxyethyl acrylate (V-190), acrylic amide (Acm), diacetone acrylamide, N-tert octylacrylamide, N,N-dimethylacrylamide, N-morpholino acrylate (MoA), and combinations thereof.

20. The adhesive article of claim 1, wherein the adhesive composition is crosslinked.

21. The adhesive composition of claim 1, wherein the adhesive composition is derived from components comprising:
an alkyl (meth)acrylate ester, wherein the alkyl group has 1 to 18 carbon atoms;
a hydrophilic, hydroxyl-functional copolymerizable monomer;
a polar monomer other than the hydrophilic, hydroxyl-functional copolymerizable monomer; and
a free-radical generating initiator.

22. The adhesive composition of claim 1, wherein the adhesive composition is derived from components comprising:
an alkyl (meth)acrylate ester, wherein the alkyl group has 1 to 18 carbon atoms;
a hydroxyl-functional copolymerizable monomer;
a (meth)acrylamide monomer; and
a free-radical generating initiator.

23. (canceled)

24. The adhesive composition of claim 22, wherein the (meth)acrylamide monomer is selected from the group consisting of: acrylic amide, diacetone acrylamide, N-tert-octylacrylamide, N,N-dimethylacrylamide, and N-morpholino acrylate.

25. The adhesive composition of claim 22, wherein the hydroxyl-functional copolymerizable monomer is selected from the group consisting of: 2-hydroxyethyl acrylate, and 2-hydroxy-propyl acrylate, and 4-hydroxybutylacrylate.

26. An adhesive composition derived from components comprising:
50 to 85 parts of an alkyl (meth)acrylate ester, wherein the alkyl group has 1 to 18 carbon atoms;
10 to 40 parts of a hydroxyl-functional copolymerizable monomer;
5 to 20 parts of a (meth)acrylamide monomer; and
a free-radical generating initiator.
